(19) United States
(12) Patent Application Publication
(10) Pub. No.: US 2011/0216030 A1
(43) Pub. Date: Sep. 8, 2011

(54) SIGNAL SENSING STRUCTURE FOR TOUCH PANELS

(76) Inventor: Wen-Chin LEE, Taipei City (TW)

(21) Appl. No.: 12/717,435

(22) Filed: Mar. 4, 2010

(51) Int. Cl. G06F 3/041

(52) U.S. Cl. 345/174

(57) ABSTRACT

A signal sensing structure for touch panels comprises a circuit substrate, a capacitive signal sensing unit located on the circuit substrate and an electromagnetic signal sensing unit. The capacitive signal sensing unit includes a first sensing array and a second sensing array, which are interlaced and respectively have a plurality of cascaded electrodes. The electrodes form a plurality of sensing blocks, and first gaps and second gaps are formed between the sensing blocks and vertical to each other. The electromagnetic signal sensing unit includes a first sensing line set and a second sensing line set, which are respectively arranged on the first gaps and the second gaps and vertical to each other. The circuit substrate has a capacitive signal and an electromagnetic signal sensing structures without mutual interference of different signals. Therefore, the present invention can accurately sense the variation of capacitive and electromagnetic signals.

### FIELD OF THE INVENTION

The present invention relates to a signal sensing structure for a touch panel, particularly to a sensing structure applied to a touch panel able to integrate the capacitive signal and the electromagnetic signal.

### BACKGROUND OF THE INVENTION

The advance of science and technology promotes the living quality of human being. Electronic products are also more and more humanized to provide convenience to users. In recent years, electronic products have an important evolution in the input devices thereof. The input devices have evolved from the conventional keyboard and press-type switch, whereby the user can input words or drawings with his finger or an electronic pen. Thus, the design of keys or switches is greatly simplified, and the user can operate the electronic product more directly and faster. Touchscreens have been widely applied to various electronic products, such as mobile phones, PDA, GPS, writing pads and the like.

The current touchscreens may be categorized into the resistive type, the capacitive type, and the electromagnetic type. R.O.C. Patent Nos. M371264, M369504 and M351407 disclose resistive type touchscreens, wherein the pressure of touch enables the electric conduction of the upper and lower electrodes, and the controller detects the voltage variation of the electrodes to calculate the position of the touch point. R.O.C. Patent Nos. M342558, M354807 and M364912 disclose capacitive type touchscreens, wherein the finger approaches the electrodes can generate a small capacitance variation to detect the position of the touch point. R.O.C. Patent Nos. I304559 and 595043 disclose electromagnetic type touchscreens, wherein an electromagnetic pen approaches the antenna board can generate a magnetic field variation signal to calculate the position of the electromagnetic pen on the antenna board.

There is also pointer input device integrating two different operative types. For example, R.O.C. patent No. M368133 discloses a pointer input device including an electromagnetic signal input structure and a resistive-type touch input structure, wherein the two input structures are stacked, whereby the user can use an electromagnetic pen or his finger to operate the electromagnetic signal input structure or the touch input structure. In addition to the abovementioned pointer input device integrating the electromagnetic type and the resistive type, there is also a pointer input device integrating the electromagnetic type and the capacitive type in the market. For example, the pointer input device shown in FIG. 1. The input device has an upper casing 11 and a lower casing 12. An electromagnetic signal sensing board 14 is interposed between the upper and lower casings 11 and 12. A capacitive signal sensing board 15 is arranged above the upper casing 11 and protected by a protection plate 13. The electromagnetic signal sensing board 14 and the capacitive signal sensing board 15 respectively have connectors 141 and 151. The connector 151 of the capacitive signal sensing board 15 penetrates the upper casing 11 to connect with the connector 141 of the electromagnetic signal sensing board 14, whereby a capacitive type touchscreen is integrated with an electromagnetic digitizer to form a composite pointer input device.

The abovementioned prior arts can indeed integrate two different operative functions to form an input device. However, two different signal sensing boards have to be stacked in the device, it not only raises the cost of material and fabrication but also increases the volume and thickness of the device. Thus, the abovementioned prior arts are less likely to apply to a compact electronic device. Further, the overlap of two different signal sensing boards attenuates or interferes with the input signals, which may cause the device to read a wrong signal and result in an erroneous result.

### SUMMARY OF THE INVENTION

The primary objective of the present invention is to overcome the abovementioned problems and provide a capacitive signal sensing structure for an electromagnetic digitizer, whereby is greatly decreased the cost of material and fabrication, is reduced the volume and thickness of the device, is obviously promoted the capability of recognizing the input signals, and is enhanced the stability and reliability of the device.

To achieve the abovementioned objective, the present invention proposes a signal sensing structure for a touch panel, which comprises a circuit substrate, a capacitive signal sensing unit and an electromagnetic signal sensing unit, wherein the capacitive signal sensing unit and the electromagnetic signal sensing unit are arranged on the circuit substrate. The capacitive signal sensing unit further comprises a first sensing array and a second sensing array, which are interlaced and respectively have a plurality of cascaded electrodes, wherein the electrodes form a plurality of sensing blocks, and wherein first gaps and second gaps are staggeredly formed between the sensing blocks. The electromagnetic signal sensing unit further comprises a first sensing line set and a second sensing line set, which are respectively arranged on the first gaps and the second gaps and vertical to each other.

The present invention aims to dispose the capacitive signal sensing unit and the electromagnetic signal sensing unit on the identical circuit substrate, thus it can use a single circuit substrate to integrate the capacitive type and electromagnetic type signal sensing structures. Therefore, the volume and thickness of the device can be efficiently reduced, and the cost of material and fabrication can also be lowered.

### BRIEF DESCRIPTION OF THE DRAWINGS

FIG. 1 is a perspective exploded view schematically showing the structure of a conventional touchscreen and an electromagnetic-type writing pad;

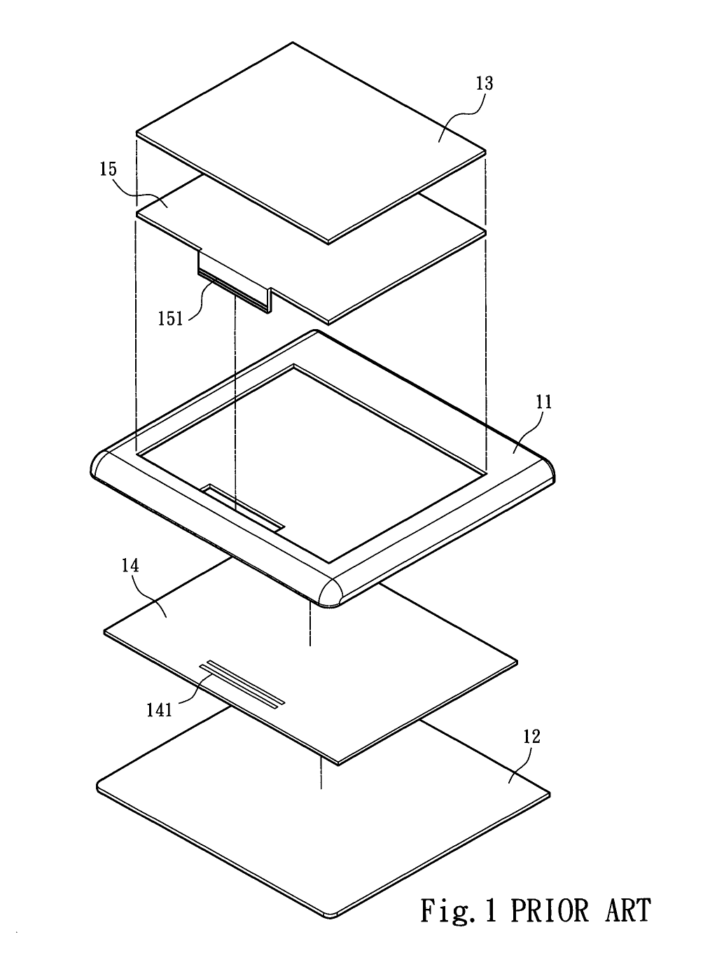

FIG. 2 is a perspective exploded view schematically showing a signal sensing structure for a touch panel of the present invention;

FIG. 3 is a diagram schematically showing the architecture of a signal sensing structure for a touch panel of the present invention;

FIG. 4 is a partially enlarged view of FIG. 3;

FIG. 5 is a diagram schematically showing another architecture of a signal sensing structure for a touch panel of the present invention;

FIG. 6 is a partially enlarged view of FIG. 5;

FIG. 7 is a diagram schematically showing an embodiment of the present invention;

FIG. 8 is a diagram schematically showing another embodiment of the present invention; and

FIG. 9 is a diagram schematically showing the operation of a signal sensing structure for a touch panel of the present invention.

### DETAILED DESCRIPTION OF THE PREFERRED EMBODIMENTS

Below, the technical contents of the present invention are described in detail in cooperation with the drawings.

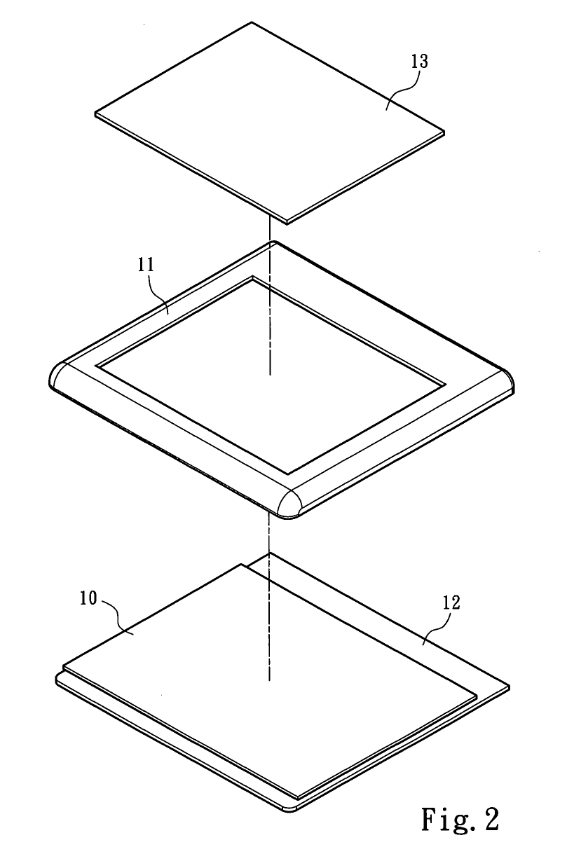

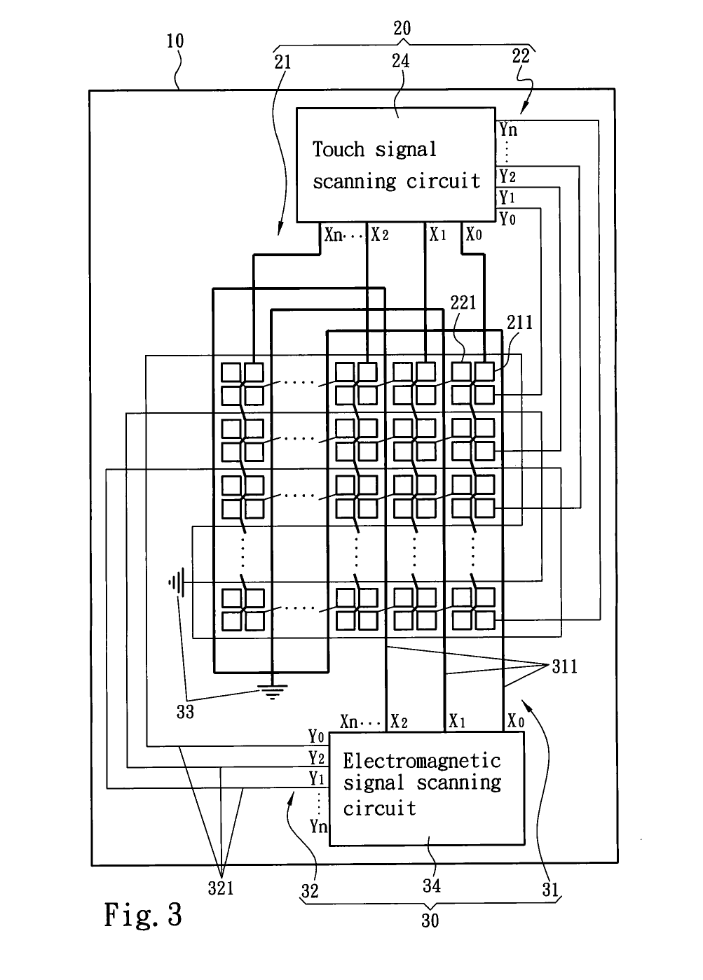

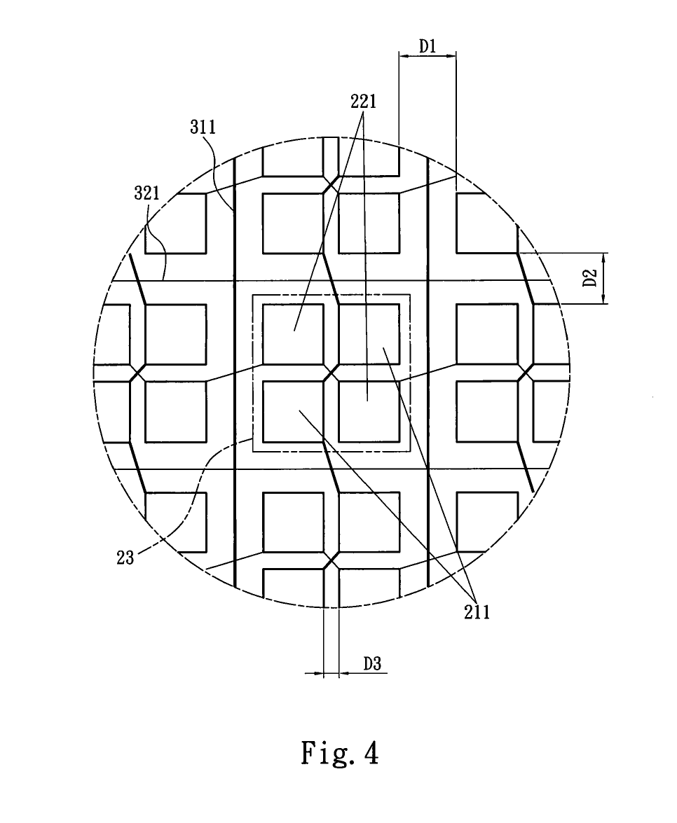

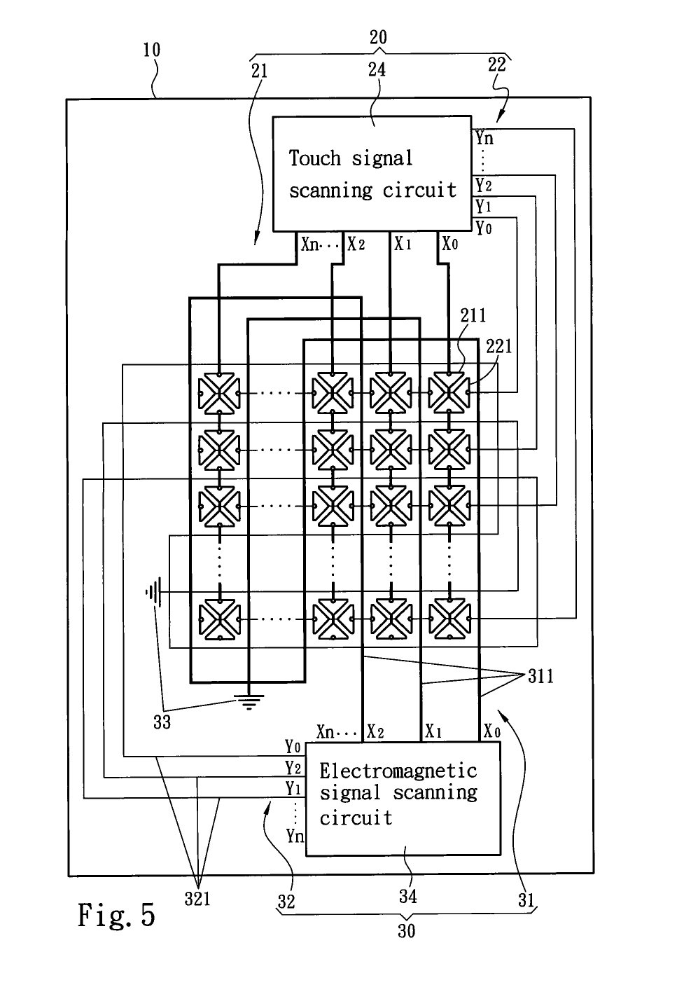

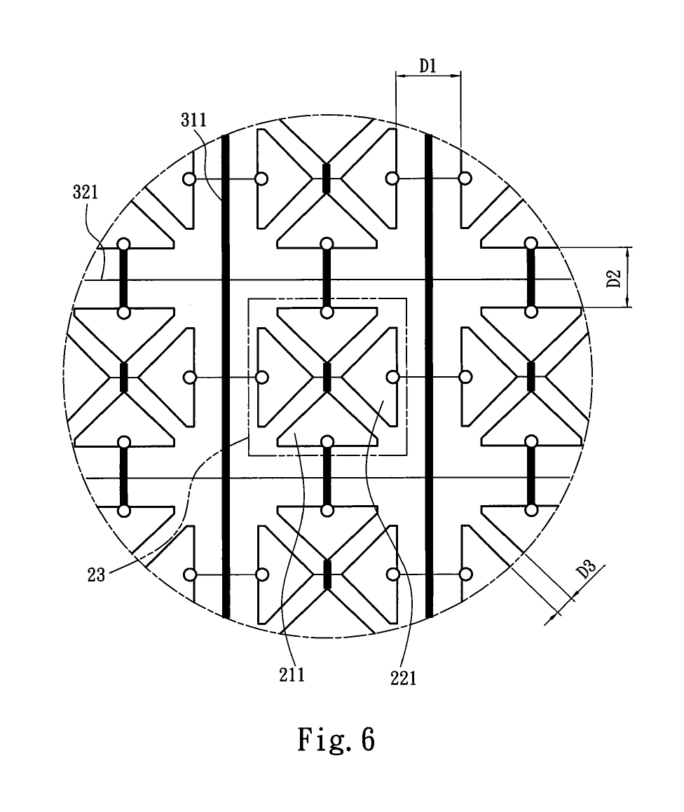

Refer to FIGS. 2-4. The signal sensing structure for a touch panel of the present invention comprises a lower casing 12, an upper casing 11 connected with the lower casing 12, a circuit substrate 10 arranged between the upper and lower casings 11 and 12, a protection plate 13 arranged above the upper casing 11, a capacitive signal sensing unit 20 formed on the circuit substrate 10, and an electromagnetic signal sensing unit 30 also formed on the circuit substrate 10, wherein the capacitive signal sensing unit 20 and the electromagnetic signal sensing unit 30 may be arranged on an identical surface of the circuit substrate 10 or respectively arranged on different surfaces of the circuit substrate 10. The capacitive signal sensing unit 20 includes a first sensing array 21 (such as X₀-Xₙ) and a second sensing array 22 (such as Y₀-Yₙ), and both sensing arrays are interlaced on the circuit substrate 10. The first sensing array 21 and the second sensing array 22 respectively have a plurality of cascaded electrodes 211 and 221, as shown in FIG. 4. The electrodes 211 and 221 form a plurality of sensing blocks 23 on the circuit substrate 10. Each sensing block 23 has two electrodes 211 of the first sensing array 21 and two electrodes 221 of the second sensing array 22. In each sensing block 23, the two electrodes 211 of the first sensing array 21 and the electrodes 221 of the second sensing array 22 are diagonally arranged at opposite angles of the sensing block 23, whereby the first and second sensing arrays 21 and 22 are interlaced. Alternatively, as shown in FIG. 5 and FIG. 6, the two electrodes 211 of the first sensing array 21 and the electrodes 221 of the second sensing array 22 are arranged at opposite sides of the sensing block 23, whereby the first and second sensing arrays 21 and 22 are also interlaced. No matter whether the electrodes 211 or 221 is arranged at opposite angles or opposite sides, first gaps D1 and second gaps D2 are formed between the adjacent sensing blocks 23 and vertical to each other. The widths of the first gaps D1 and the second gaps D2 are greater than the width of the gaps D3 between two adjacent electrodes 211 and 221 in the sensing block 23. The first gaps D1 are parallel to the first sensing array 21, and the second gaps D2 are parallel to the second sensing array 22.

Refer to FIG. 5 and FIG. 6. The electromagnetic signal sensing unit 30 formed on the circuit substrate 10 includes a first sensing line set 31 arranged on the first gaps D1 and a second sensing line set 32 arranged on the second gaps D2. The first sensing line set 31 is vertical to the second sensing line set 32. The first sensing line set 31 has a plurality of sensing lines 311 (such as X₀-Xₙ) arranged on the first gaps D1. The second sensing line set 32 has a plurality of sensing lines 321 (such as Y₀-Yₙ) arranged on the second gaps D2. The first sensing line set 31 and the second sensing line set 32 respectively have grounding terminals 33. The grounding terminals 33 are respectively connected to the sensing lines 311 and 321. Thus, the first sensing line set 31 and the second sensing line set 32 respectively form electromagnetic signal sensing loops. Thereby is established the main structure of the present invention. In one embodiment, the circuit substrate 10 has a touch signal scanning circuit 24 and an electromagnetic signal scanning circuit 34. The touch signal scanning circuit 24 is electrically connected to the capacitive signal sensing unit 20 to scan the signals of the capacitive signal sensing unit 20. The electromagnetic signal scanning circuit 34 is electrically connected to the electromagnetic signal sensing unit 30 to scan the signals of the electromagnetic signal sensing unit 30.

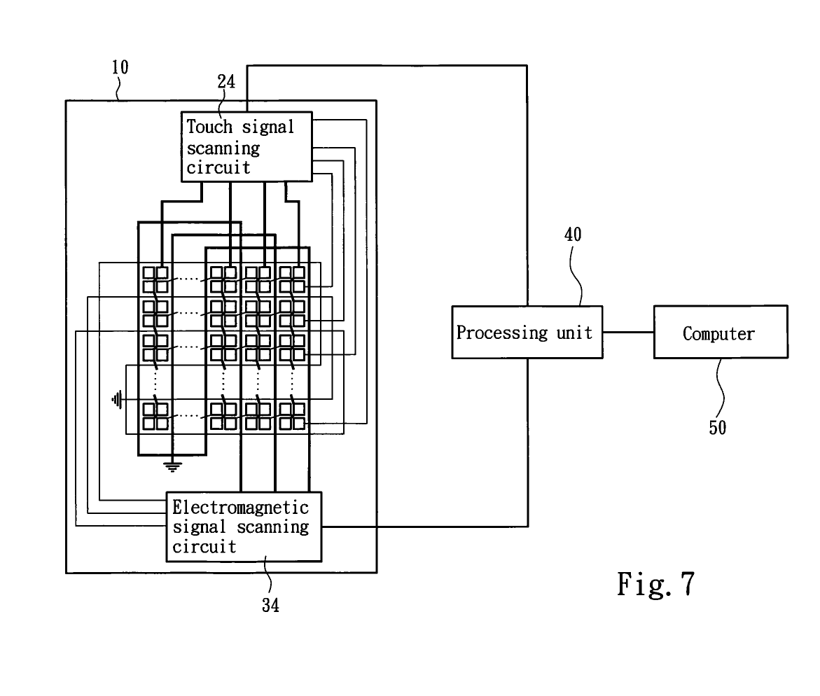

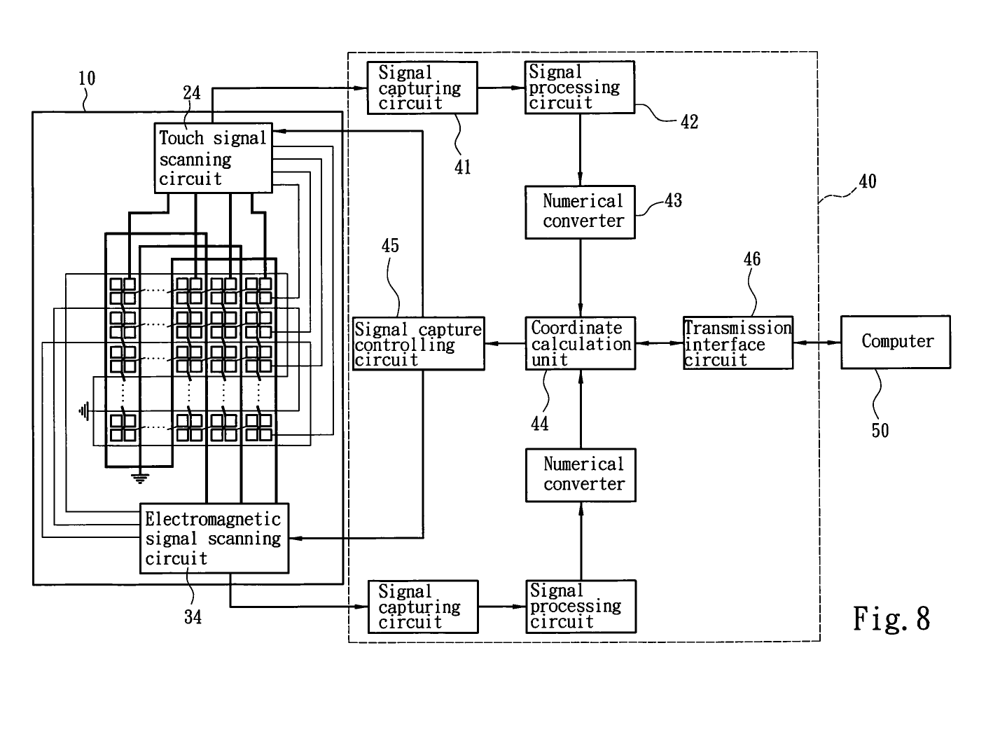

Refer to FIG. 7. The circuit substrate 10 is connected to a processing unit 40. The processing unit 40 analyzes the signals obtained by the touch signal scanning circuit 24 and the electromagnetic signal scanning circuit 34. Then, the processing unit 40 sends the analysis results to a computer 50 to execute the instructions corresponding to the signals. Refer to FIG. 8. The processing unit 40 has signal capturing circuits 41 respectively connected with the touch signal scanning circuit 24 and the electromagnetic signal scanning circuit 34 to capture the touch signal or the electromagnetic signal. A signal processing circuit 42 and a numerical converter 43 are connected to the rear end of each of the signal capturing circuits 41 to convert the touch signal or the electromagnetic signal into digital data. The digital data calculates the positional coordinates where the touch signal or electromagnetic signal is input into the circuit substrate 10 through a coordinate calculation unit 44. The positional coordinates are transmitted to the computer 50 via a transmission interface circuit 46. The coordinate calculation unit 44 may use a signal capture controlling circuit 45 to control the signal scanning functions of the touch signal scanning circuit 24 and electromagnetic signal scanning circuit 34.

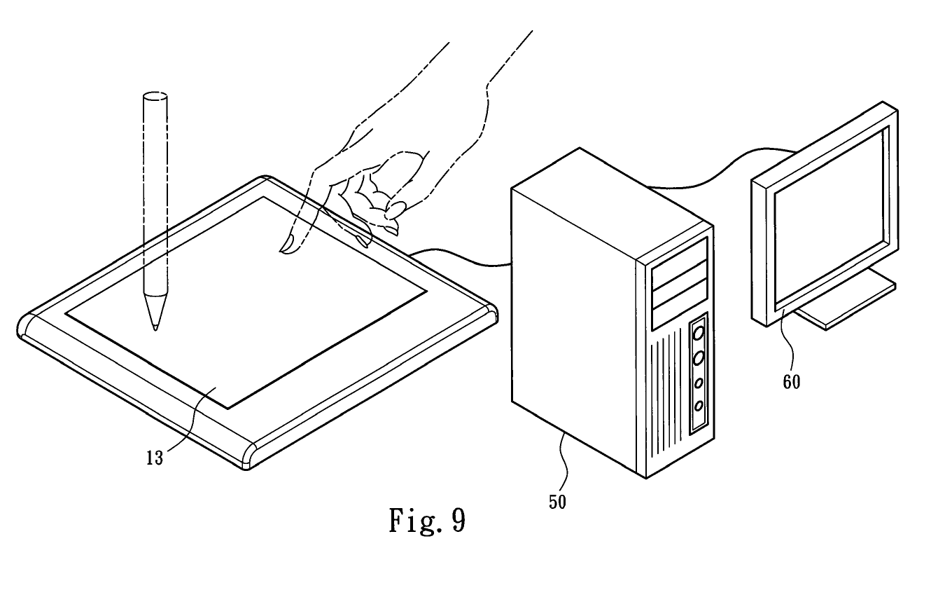

Refer to FIG. 8 and FIG. 9. In one embodiment, the combination of the circuit substrate 10 and processing unit 40 can function as a device for sensing and capturing the capacitive signal and the electromagnetic signal. The combination of the circuit substrate 10 and processing unit 40 connects with the computer 50 can function as a pointer device of the computer 50. Moreover, the circuit substrate 10 and processing unit 40 can integrate with a display 60. Once the display 60 is connected with the computer 50, the display 60 has functions of touch control, writing and drafting. The circuit substrate 10 and processing unit 40 can also integrate with a notebook computer. When the user's finger contacts the protection plate 13 over the circuit substrate 10, the first and second sensing arrays 21 and 22 of the capacitive signal sensing unit 20 detect the capacitance variation induced by the finger. Then, the processing unit 40 can calculate the position where the finger contacts the circuit substrate 10. The circuit substrate 10 and processing unit 40 can also capture the position where the electronic pen points to the circuit substrate 10, wherein the first sensing line set 31 and second sensing line set 32 of the electromagnetic signal sensing unit 30 detects the magnetic signal of the electronic pen. Then, the processing unit 40 can calculate the position where the electronic pen points to the circuit substrate 10. The circuit substrate 10 and processing unit 40 are connected to the notebook computer via the transmission interface circuit. Thus, the circuit substrate 10 and processing unit 40 can function as a pointer device of the notebook computer.

In summary, the capacitive signal sensing unit 20 of the present invention has a first sensing array 21 and a second sensing array 22, which are interlaced on the circuit substrate 10. The first sensing array 21 and the second sensing array 22 respectively have a plurality of cascaded electrodes 211 and 221. The electrodes 211 and 221 form a plurality of sensing blocks 23. First gaps D1 and second gaps D2 are formed between the sensing blocks 23 and vertical to each other. The electromagnetic signal sensing unit 30 is formed on the circuit substrate 10 and has a first sensing line set 31 and a second sensing line set 32, which are respectively arranged on the first gaps D1 and the second gaps D2 and vertical to each other. In the present invention, the capacitive signal sensing unit 20 and the electromagnetic signal sensing unit 30 are installed on an identical circuit substrate 10 without mutual interference. Thus, the processing unit 40 can accurately sense and capture the input capacitive signal and electromagnetic signal.

The embodiments described above are only to exemplify the present invention but not to limit the scope of the present invention. Any equivalent modification or variation according to the spirit of the present invention is to be also included within the scope of the present invention.

What is claimed is:

1. A signal sensing structure for touch panels, comprising:
a circuit substrate;
a capacitive signal sensing unit including a first sensing array and a second sensing array, which are interlaced on the circuit substrate and respectively include a plurality of cascaded electrodes, wherein the electrodes form a plurality of sensing blocks, and first gaps and second gaps are formed between the sensing blocks and vertical to each other; and
an electromagnetic signal sensing unit formed on the circuit substrate including a first sensing line set and a second sensing line set, which are respectively arranged on the first gaps and the second gaps and vertical to each other.

2. The signal sensing structure according to claim 1, wherein each of the sensing blocks has two electrodes of the first sensing array and two electrodes of the second sensing array.

3. The signal sensing structure according to claim 2, wherein the two electrodes of the first sensing array and the two electrodes of the second sensing array are diagonally arranged at opposite angles of the sensing block.

4. The signal sensing structure according to claim 2, wherein the two electrodes of the first sensing array and the two electrodes of the second sensing array are arranged at opposite sides of the sensing block.

5. The signal sensing structure according to claim 1, wherein the first gaps are parallel to the first sensing array, and the second gaps are parallel to the second sensing array.

6. The signal sensing structure according to claim 1, wherein the first sensing line set and the second sensing line set respectively have a plurality of sensing lines.

7. The signal sensing structure according to claim 6, wherein the first sensing line set and the second sensing line set respectively have grounding terminals connected to the sensing lines.

8. The signal sensing structure according to claim 1, wherein the circuit substrate has a touch signal scanning circuit and an electromagnetic signal scanning circuit; the touch signal scanning circuit is electrically connected to the capacitive signal sensing unit; the electromagnetic signal scanning circuit is electrically connected to the electromagnetic signal sensing unit.

9. The signal sensing structure according to claim 1, wherein the capacitive signal sensing unit and the electromagnetic signal sensing unit are arranged on an identical surface of the circuit substrate.

10. The signal sensing structure according to claim 1, wherein the capacitive signal sensing unit and the electromagnetic signal sensing unit are respectively arranged on different surfaces of the circuit substrate.
